(19) United States
(12) Patent Application Publication
(10) Pub. No.: US 2003/0128191 A1
(43) Pub. Date: Jul. 10, 2003

(54) Dynamically variable user operable input device

(76) Inventors: Eric M. Strasser, Palo Alta, CA (US); Edward O. Clapper, Tempe, AZ (US)

Correspondence Address: Timothy N. Trop, TROP, PRUNER & HU, P.C., 8554 KATY FWY, STE 100, HOUSTON, TX, 77024-1805, US

(21) Appl. No.: 10/040,422

(22) Filed: Jan. 7, 2002

(51) Int. Cl. G09G 5/00

(52) U.S. Cl. 345/173

(57) ABSTRACT

A user operable element may be positioned over a display such that an image element formed on the display may be viewed through a transparent portion of the operable element. The operable element may be coupled to a switch and/or a feedback mechanism that may provide auditory and/or tactile feedback to the user.

### BACKGROUND

This invention relates to input devices for processor-based systems.

Conventional switches (such as, for example, push-button switches, rocker switches and toggle switches) are easy for people to use—it is obvious how to operate them and, when operated, they provide an immediate, visual and tactile indication that actuation has been achieved. One can see and feel them move. For example, push-button switches typically depress until they reach a stop; toggle switches and rocker switches snap between “off” and “on” positions. Conventional switches, however, typically have permanent labels or legends—for example, a number or word printed on a button or key cap. This limits the versatility of the switch. It is difficult to use the same switch for multiple functions because the switch has a single label or legend.

Touch screens provide the ability to change the legend or label associated with a button image element appearing on the screen. However, unlike conventional push-button switches, touch screens do not provide tactile feedback to the user—i.e., one cannot feel the operation of the switch. Moreover, the time required by the system to process the input can result in a confusing delay in any auditory or visual indication of actuation that the system may be programmed to provide. Also, since most popular computer operating systems have graphical user interfaces that utilize depictions of buttons which are selected by “clicking” on the button image with a mouse or other pointing device, it may not be immediately apparent to new users of touch screen systems whether to push on the screen or find a pointing device to click on the button image.

What is needed is a device that has the versatility of a touch screen while still being as easy to operate as a conventional, mechanical switch.

### BRIEF DESCRIPTION OF THE DRAWINGS

FIG. 1 is a front elevational view of one embodiment;

FIG. 2 is a cross-sectional view of a portion of the embodiment of FIG. 1 taken generally along line 2-2;

FIG. 3 is a cross-sectional view of another embodiment;

FIG. 4 is a cross-sectional view of a third embodiment;

FIG. 5 is a cross-sectional view of a fourth embodiment;

FIG. 6 is a cross-sectional view of a fifth embodiment;

FIG. 7 is a graph showing a characteristic of one hypothetical element which may be employed in some embodiments; and

FIG. 8 is a schematic hardware depiction for one embodiment.

### DETAILED DESCRIPTION

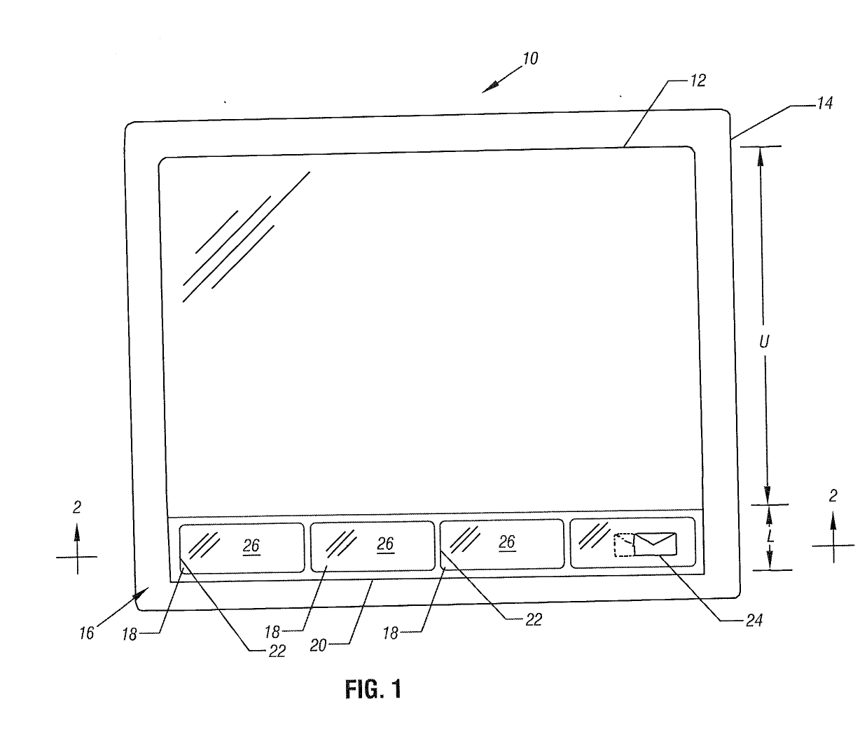

Referring to FIG. 1, a processor-based system 10 may include an input/output device 16 in accordance with one embodiment. The processor-based system 10 may include a display 12 supported within a chassis 14. The processor-based system 10 may be, for example, a desktop or laptop computer, a portable device such as a personal digital assistant, or an appliance such as an automatic teller machine. The display 12 may be, for example, a cathode ray tube (CRT) or a liquid crystal display (LCD).

A plurality of user operable elements 26 may overlie the front lower portion L of display 12. The upper portion U of display 12 may be used in a conventional manner to display information.

Each operable element 26 may comprise at least one transparent region 18 for viewing image elements 24 displayed in the lower portion L of the underlying display 12. The operable elements 26 may include a frame 20 having opaque regions 22. An opaque region 22 may surround each transparent region 18 to create a visible separation between adjacent transparent regions 18. The opaque region 22 may also provide a visual separation between lower portion L and upper portion U of display 12 in some embodiments.

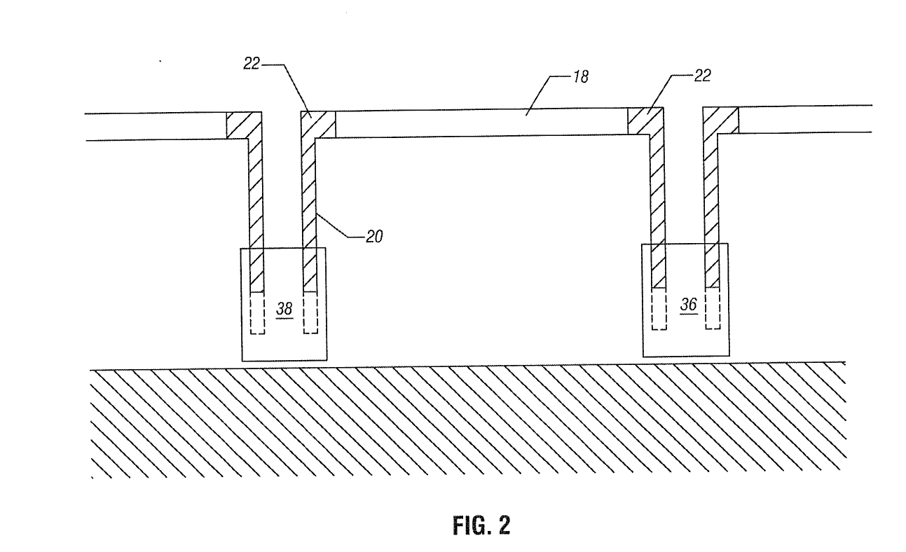

As shown in FIG. 2, the operable elements 26 may each be coupled to a switch 36 and/or tactile feedback mechanism 38 such that operation of the operable element 26 actuates the switch 36 and/or the feedback mechanism 38. The switch 36 or mechanism 38 may be manually operated by depressing the transparent region 18. The transparent region 18 is part of the frame 20 that moves. The transparent region 18 typically does not move as an independent entity. In the depressed state, shown in dashed lines in FIG. 2, the elements 26 extend towards the display 12, operating the switches 36 and/or mechanisms 38.

The switch 36 may be actuated to indicate a user input selection to the processor-based system 10. Examples of electrical switches include push-button switches, rotary switches and pivoting switches.

The feedback mechanism 38 may provide auditory and/or tactile feedback to the user to signal switch actuation. The feedback mechanism 38 may be incorporated into switch 36. Certain types of switches inherently provide tactile and/or auditory feedback upon actuation. An example of auditory feedback is a “click” sound produced upon switch actuation. An example of tactile feedback is an “over-center” action.

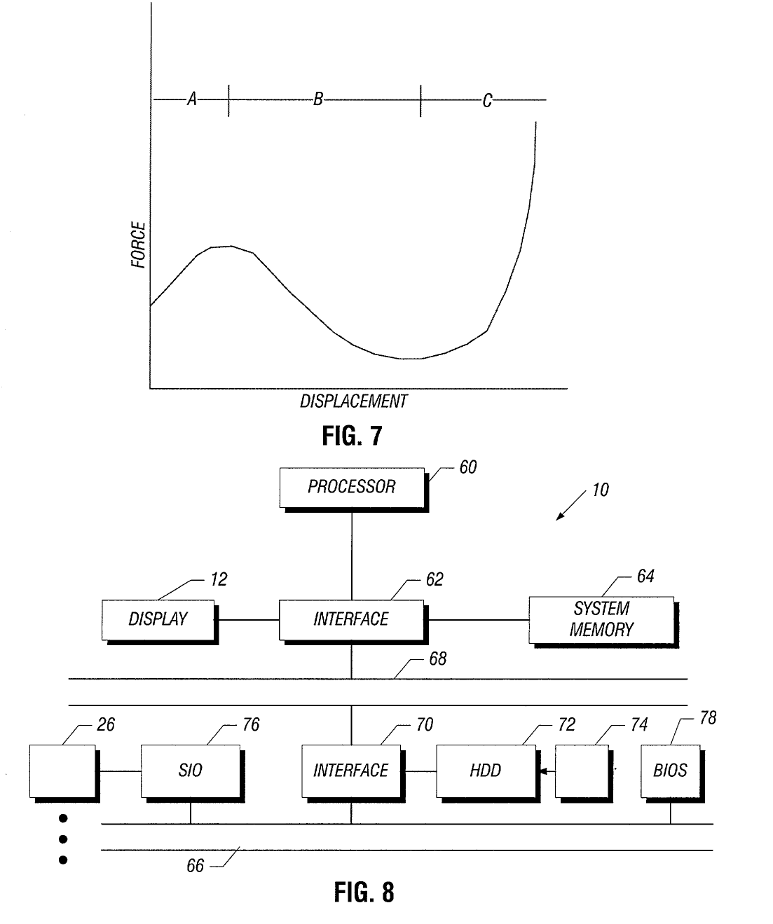

In one hypothetical embodiment, shown in FIG. 7, the resistance to actuation is a function of displacement of a feedback mechanism 38. A force in opposition to actuation of the element 26 builds during the first portion A of such operation and then abruptly decreases with further displacement such that less resistance to further operation may be provided in a second portion B of the actuation operation. In a third portion C, the resistance may build rapidly as the element 26 reaches a displacement limit stop. The function depicted in FIG. 7 is a non-monotonic function—i.e., a function wherein the dependent variable (force) does not always increase or decrease as the value of the independent variable (displacement) increases or decreases.

The tactile feedback mechanism 38 may comprise a collapsible rubber dome wherein force is applied to the top of the dome causing the dome to crumple in a way that generates a non-monotonic response. As another example, the mechanism 38 may include a spring that breaks out of column when the operable element 26 is operated. The spring may be contained in an enclosure of appropriate size such that the spring contacts the sides of the enclosure when it breaks out of column producing an audible “click”.

In operation, the processor-based system 10 may generate an image element 24 to be displayed for user selection on display 12 beneath one or more operable elements 26. The image element 24 may serve as a label or legend for operable element 26. The image element 24 is viewed through transparent region 18 of operable element 26. A user may select a particular operable element 26 in response to display of the image element 24. A user may actuate the operable element 26 by applying pressure to the transparent region 18 in a direction orthogonal to and towards the display 12. Depressing the transparent region 18 typically causes its attached frame 20 to move towards the display 12. The frame 20 may be operatively coupled to switch 36 and/or feedback mechanism 38 such that sufficient movement of the frame 20 towards the display 28 causes actuation of switch 36 and/or feedback mechanism 38. In this way, a user operable element 26 having feedback may be provided with the dynamic legends heretofore available only with expensive touch screen systems.

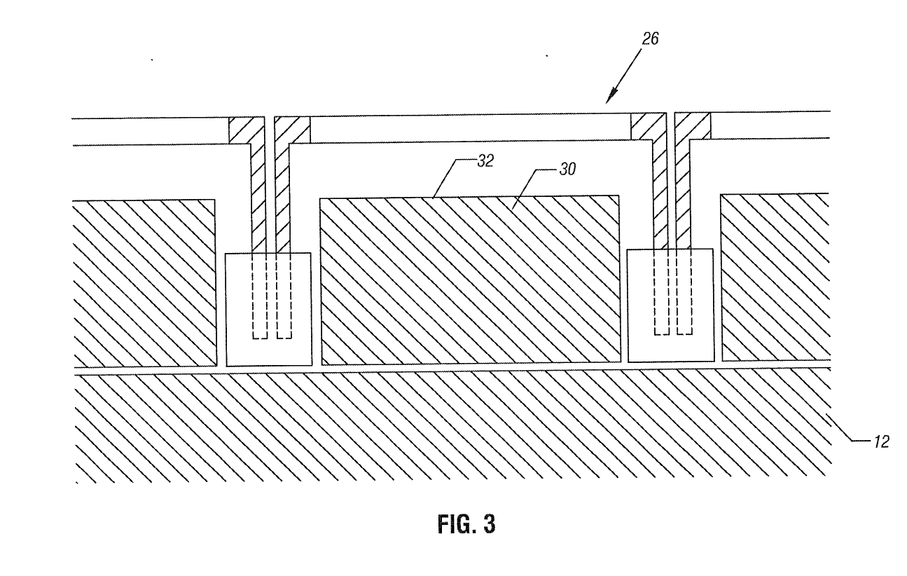

Rather than viewing the display 12 directly through transparent region 18 of the operable element 26, image enhancing devices may be employed in other embodiments. For example, a light transmitter 30 may be interposed between transparent region 18 and display 12 as shown in FIG. 3. The light transmitter 30 may be, for example, a light pipe or a lens which may magnify the image displayed on the underlying display 12.

The light transmitter 30 may be positioned to be in optical communication with the display 12 that underlies the operable element 26. The light transmitter 30 may have a rear surface 34 and a front surface 32 disposed to be visible to the user through transparent region 18. The light transmitter 30 may be, for example, a light pipe comprising a bundle of strands of optical fibers. By maintaining the relative position of the many strands within the bundle (a coherent fiber bundle), it is possible to pipe an image from one end of the bundle to the other.

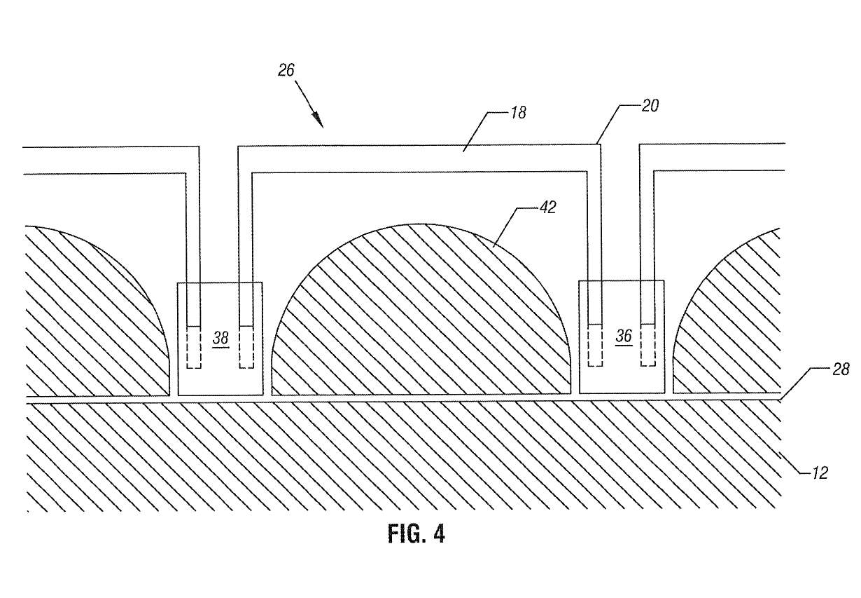

In another embodiment, the light transmitter 30 may comprise a lens 42 that magnifies the image on the display making the image more readily viewable by the user 12, as shown in FIG. 4. The lens 42 may be in optical communication with display 12 to create an enlarged image of the underlying image element 24 on display 12.

A visual indication of switch actuation may be provided under program control in a processor-based system 10 by changing the image element 24 on the display 12. For example, the image element 24 associated with a given operable element 26 may be changed upon actuation of the switch 36. Such a change in image may include, among many other possibilities, displaying a different background color, altering the brightness of the display 12 in the region underlying the operable element 26 or, as shown in the embodiment depicted in FIG. 1, causing the image element 24 to appear to “dance” to the right and back.

The function of a given operable element 26 may be changed under program control. In this way, a limited number of operable elements 26 comprising an input device for a processor-based system 10 may be used to accomplish a greater number of functions inasmuch as the legend appearing on the face of an operable element 26 may be automatically changed to match a change in the function of the operable element 26.

Examples of image elements 24 include graphics, textual legends, icons and color blocks. The image element 24 may connote, for example, the function that will be performed when the operable element 26 is operated or the state of the switch 36. The image elements 24 may be static or dynamic.

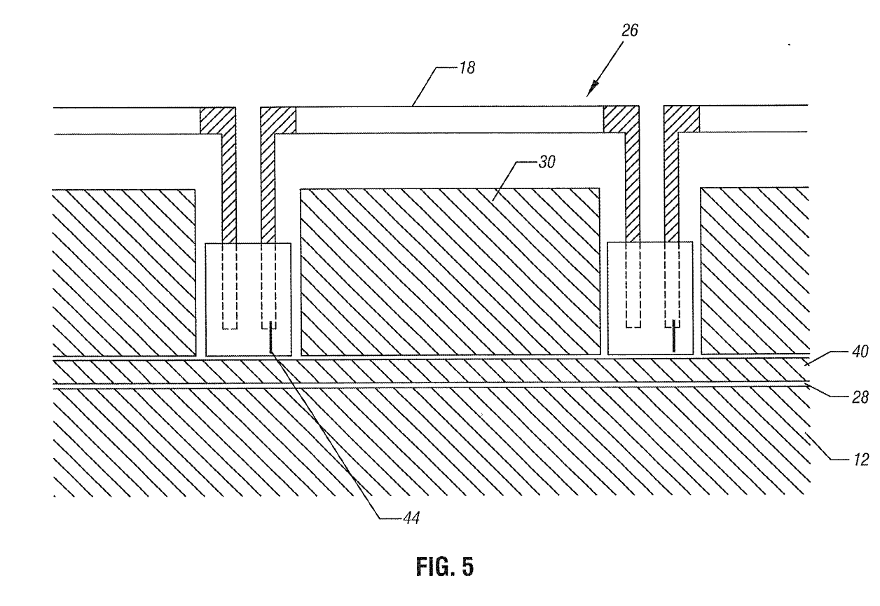

A touch screen membrane 40 may be fitted over a display 12, as shown in FIG. 5. The operable element 26 may comprise a feedback mechanism 38 for providing tactile and/or auditory feedback as described above. The operable element 26 may further comprise contactor 44 for actuating touch screen membrane 40 when operable element 26 is operated by, for example, depressing transparent region 18 of frame 20.

The contactor 44 may concentrate the force applied to touch screen membrane 40 in a smaller and better defined area than would be the case if the touch screen membrane 40 were contacted with the user's finger. This may be advantageous for achieving positive switch actuation with minimal pressure applied by the user.

In embodiments comprising a touch screen membrane 40, additional switch elements may not be required, but a tactile feedback mechanism 38 for providing a tactile indication of switch actuation may be incorporated. If a touch screen membrane 40 is employed in a programmed system, auditory feedback may be provided under program control by causing a “click” or other sound to be produced when the system controller detects actuation of the touch screen membrane 40. The sound may be produced by a speaker and associated audio circuitry or, as another example, by an electromechanical clicker. An example of such a clicker is device comprising ferromagnetic material which is brought into contact with a pole of an electromagnet when the magnet is energized.

In this way, the intuitive operation and tactile feedback of a conventional, push-button switch may be achieved in a system comprising a touch screen. Conventional touch screens provide no tactile feedback to provide a sensory cue to the user of how much pressure is required for actuation. A touch screen does, however, provide the ability to change the legend on a “button” under program control. Such legend may also be animated and/or colored with any color that the display may be capable of generating.

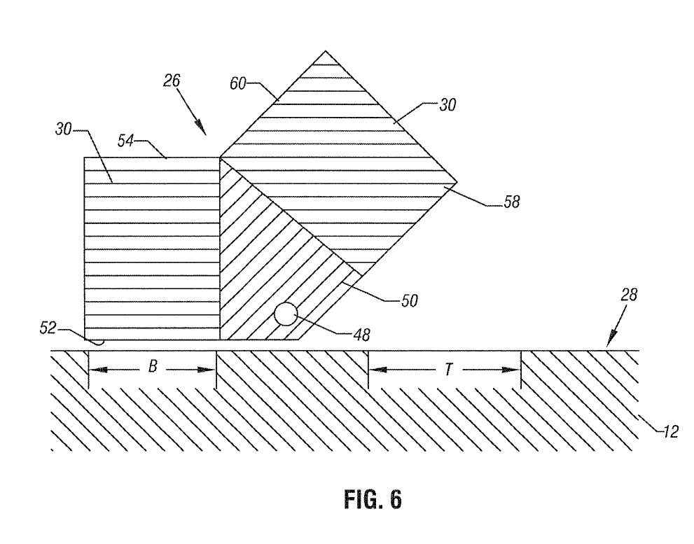

In another embodiment, shown in FIG. 6, operable element 26 may comprise a rocker switch body 50. The rocker switch body 50 may comprise light transmitters 30 and a pivot 48. The rocker switch body 50 may be positioned over a display 12. The light transmitters 30 may have opposing paired surfaces 52, 54 and 58, 60.

When an operable element 26 is in one state (which may be an “off” state, for example), the surface 52 of the light transmitter 30 may be in proximity and substantially parallel to the region B of the display 12. An image formed by the display 12 in the region B may be transmitted by the light transmitter 30 from surface 52 to surface 54 where it may be viewed by the user.

When the operable element 26 is operated by, for example, pressing the surface 60, the switch body 50 may rotate about pivot 48 bringing the surface 58 of the light transmitter 30 closer to the region T of display surface 28 while the surface 52 simultaneously moves away from display 12. This action causes a change of state (which may be from an “off” state to an “on” state, for example). When the surface 58 is proximate to and substantially parallel with display 12, image elements 24 in region T are transmitted by the light transmitter 30 to the surface 60 where the image elements 24 may be visible to a user viewing the front of the switch body 50.

The change of state of a switch (not shown) operatively coupled to switch body 50 may be detected by the processor-based system 10 which in turn may cause the legend associated with the operable element 26 to move from the display region B to the display region T under program control so as to remain visible to the user. The content or design of the legend may also be changed under program control to indicate the change in the switch state.

Referring to FIG. 8, the system 10 may include a processor 60 coupled to an interface 62. In one embodiment, the interface 62 may be coupled to the display 12, system memory 64, and a bus 68.

The bus 68 may, in turn, be coupled to an interface 70. The interface 70 may be coupled to a bus 66 and a hard disk drive 72 or other storage medium. The drive 72 may store software 74.

The bus 66 may couple a serial input/output (SIO) device 76. The SIO device 76 may be connected to the operable element 26, for example, the switch 36 or mechanism 38. Thus, a corresponding region of the display 12 may respond to or detect an actuation of the element 26 or the user may respond to information on the display 12. This may be done under control of a software 74 in one embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor-based system comprising:
a display;
a user operable element positioned over the display to enable viewing of the display through the element, said operable element having a non-monotonic response to user actuation; and
a switch operatively coupled to the operable element.

2. A processor-based system as recited in claim 1 wherein the display is a cathode ray tube.

3. A processor-based system as recited in claim 1 wherein the display is a liquid crystal display.

4. A processor-based system as recited in claim 1 wherein the user-operable element is a push button.

5. A processor-based system as recited in claim 1 wherein the user-operable element is a rocker.

6. A processor-based system as recited in claim 1 further comprising a lens positioned over the display to enable viewing of the display through the lens.

7. A processor-based system as recited in claim 1 further comprising a light pipe positioned over the display to enable viewing of the display through the light pipe.

8. A processor-based system as recited in claim 10 wherein the light pipe comprises a fiber optic bundle.

9. An apparatus comprising:
a processor;
a display operatively coupled to said processor;
a user operable element positioned over the display to enable viewing of the display through the element, said operable element having a non-monotonic response to user actuation; and,
a switch mechanically connected to the operable element and electrically coupled to the processor.

10. An apparatus as recited in claim 9 wherein the user-operable element is a push button.

11. A processor-based system comprising:
a touch screen display;
a user operable element positioned over the display to enable viewing of the display through the element, said operable element having a non-monotonic response to user actuation; and,
a contactor operatively coupled to the operable element such that actuation of said element causes contact with the touch screen display.

12. A processor-based system as recited in claim 13 wherein the user-operable element is a push button.

13. A processor-based system comprising:
a display;
a user-operable element positioned over the display to enable viewing of the display through the element;
a switch operatively coupled to said operable element; and
a resilient element connected to said operable element such that operation of said operable element is resisted with a non-monotonic force.

14. A processor-based system as recited in claim 13 wherein the resilient element is a rubber dome.

15. A processor-based system as recited in claim 13 wherein the resilient element is a coil spring which breaks out of column in response to compressive force.

16. A processor-based system comprising:
a display;
a user-operable element having a lens positioned over said display to enable viewing of the display through the lens; and,
a switch operatively coupled to said operable element.

17. A processor-based system as recited in claim 16 wherein the display is a cathode ray tube.

18. A processor-based system as recited in claim 16 wherein the display is a liquid crystal display.

19. A processor-based system as recited in claim 16 wherein the user-operable element is a push button.

20. A processor-based system comprising:
a display;
a user-operable element having a light pipe positioned over said display to enable viewing of the display through the light pipe; and,
a switch operatively coupled to said operable element.

21. A processor-based system as recited in claim 20 wherein the display is a cathode ray tube.

22. A processor-based system as recited in claim 20 wherein the display is a liquid crystal display.

23. A processor-based system as recited in claim 20 wherein the user-operable element is a push button.

24. A processor-based system as recited in claim 20 wherein the user-operable element is a rocker.

25. A processor-based system as recited in claim 20 wherein the light pipe comprises a fiber optic bundle.

26. A method comprising:
providing a user-operable element for installation over a display;
providing a transparent part on the user-operable element that allows a portion of the display to be viewed through said element; and
creating a non-monotonic response to actuation of said element.

27. A method as recited in claim 26 wherein providing a transparent part includes providing a lens.

28. A method as recited in claim 26 wherein providing a transparent part includes providing a light pipe.

29. A method as recited in claim 26 wherein providing a user-operable element includes providing a push button.

30. A method as recited in claim 26 wherein providing a user-operable element for installation over a display includes providing an element for installation over a touch screen display.
